(19) United States
(12) Patent Application Publication
(10) Pub. No.: US 2022/0139296 A1
(43) Pub. Date: May 5, 2022

(54) IMAGE INFORMATION PROCESSING METHOD, ELECTRONIC DEVICE AND STORAGE MEDIUM

(71) Applicant: GUANGDONG OPPO MOBILE TELECOMMUNICATIONS CORP., LTD., Dongguan (CN)

(72) Inventors: Jie HU, Dongguan (CN); Haitao ZHOU, Dongguan (CN)

(21) Appl. No.: 17/575,978

(22) Filed: Jan. 14, 2022

Related U.S. Application Data
(63) Continuation of application No. PCT/CN2020/099086, filed on Jun. 30, 2020.

(30) Foreign Application Priority Data
Jul. 17, 2019 (CN) 201910647084.0

(51) Int. Cl. G09G 3/20; G06F 9/451

(52) U.S. Cl. CPC G09G 3/2096; G06F 9/451; G09G 2320/0242; G09G 2360/144; G09G 2340/06

(57) ABSTRACT

Disclosed are an image information processing method, an electronic device and a storage medium. The method includes: acquiring a color gamut space configured for an interface to be displayed; acquiring a color gamut space of a screen; if the color gamut space configured for the interface to be displayed is inconsistent with the color gamut space of the screen, detecting whether a color gamut space conversion condition is satisfied; and if the color gamut space conversion condition is satisfied, converting the color gamut space of the screen to be consistent with the color gamut space configured for the interface to be displayed.

### CROSS-REFERENCE TO RELATED APPLICATIONS

The present application is a continuation of International Patent Application No. PCT/CN2020/099086, filed on Jun. 30, 2020, which claims priority to Chinese Patent Application No. 201910647084.0, filed on Jul. 17, 2019, the entire disclosures of which are incorporated herein by reference.

### TECHNICAL FIELD

The present application relates to the technical field of image processing technologies, and in particular, to an image information processing method, an electronic device, and a storage medium.

### BACKGROUND

With the development of society, an application range of electronic devices with screens has been continuously expanding. For example, screens are used to display interfaces, videos, and other images. Related electronic devices may not respond well to display effect when interfaces are designed, resulting in poor user experience.

### SUMMARY OF THE DISCLOSURE

In a first aspect, the present application provides an image information processing method comprising: acquiring a color gamut space of a target interface and a color gamut space of a screen; in response to that the color gamut space of the target interface is inconsistent with the color gamut space of the screen, detecting whether a color gamut space conversion condition is met; and in response to that the color gamut space conversion condition is met, converting the color gamut space of the screen to be consistent with the color gamut space of the target interface.

In a second aspect, the present application provides an electronic device comprising one or more processor and memory; one or more program is stored in the memory and configured to be executed by the one or more processor, and the one or more program is configured to execute the above method.

In a third aspect, the present application provides a non-transitory computer-readable storage medium, the computer-readable storage medium stores program codes therein, wherein the program codes, when being run by a processor, execute the above method.

### BRIEF DESCRIPTION OF THE DRAWINGS

In order to describe technical solutions in embodiments of the present application more clearly, drawings required being used in description of the embodiments will be simply introduced below. Obviously, the drawings in the following description are merely some embodiments of the present application. For one of ordinary skill in the art, it is also possible to obtain other drawings according to these drawings without paying any creative work.

FIG. 1 shows a diagram of an image processing environment provided by an embodiment of the present application.

FIG. 2 shows a flow chart of an image information processing method provided by an embodiment of the present application.

FIG. 3 shows a schematic view of control-class objects in another image information processing method provided by an embodiment of the present application.

FIG. 4 shows a flow chart of an image information processing method provided by another embodiment of the present application.

FIG. 5 shows a schematic view of a blank area in an image information processing method provided by another embodiment of the present application.

FIG. 6 shows a flow chart of an image information processing method provided by further another embodiment of the present application.

FIG. 7 shows a structural block diagram of an image information processing apparatus provided by an embodiment of the present application.

FIG. 8 shows a structural block diagram of another image information processing apparatus provided by another embodiment of the present application.

FIG. 9 shows a structural block diagram of an electronic device of the present application, which is configured to execute an image information processing method according to an embodiment of the present application.

FIG. 10 is a storage unit of an embodiment of the present application, which is configured to store or carry program codes implementing an image information processing method according to an embodiment of the present application.

### DETAILED DESCRIPTION

The technical solutions in the embodiments of the present application will be clearly and completely described below in conjunction with the drawings in the embodiments of the present application. Obviously, the described embodiments are only some embodiments of the present application, rather than all embodiments. Based on the embodiments in the present application, all other embodiments obtained by one of ordinary skill in the art without creative work shall fall within the protection scope of the present application.

With improvement of hardware performance of electronic devices, interfaces of more electronic devices use interfaces with higher definition as the interface background interfaces, or colors of interfaces are designed to be richer and more colorful. However, the inventor has found in research that, in addition to information of an interface itself, factors that affect display effect of the interface further include a degree of matching between information configured for the interface and a screen on which the interface is displayed.

Color gamut space is taken as an example. Color gamut is just the color gamut space, which is a method of encoding colors, and also refers to the sum of colors that can be produced by a technical system. In computer graphics processing, the color gamut is a certain complete subset of colors. The color gamut space may include sRGB color gamut, Adobe RGB color gamut, or DCI-P3 color gamut. Among them, sRGB is one of the earliest color gamut standards and obtain support by W3C, Exif, Intel, Pantone, Corel and many other industry manufacturers from the industry. The Adobe RGB color gamut mainly improves display on the cyan system, so it can cover about 50% of the CIE 1931 XYZ color space. DCI-P3 is a color gamut used in digital cinemas. It is a color gamut standard dominated by human visual experience, and matches all color gamuts that can be shown in movie scenes as much as possible. It is not the widest color gamut standard (currently the latest standard is BT.2020), but is above Rec.709 standard and has a wider range of red/green series.

The inventor has found that when color gamut space configured for an interface is inconsistent with color gamut space of a screen, directly displaying an interface with inconsistent color gamut space on the screen will cause that display effect of an original designed interface is unable to be displayed. For example, when an interface corresponding to a wider color gamut space is displayed on a screen corresponding to a narrower color gamut space, the displayed interface will become more oversaturated. When an interface corresponding to a narrower color gamut space is displayed on a screen corresponding to a wider color gamut space, the displayed interface will become dimmer.

Therefore, in order to improve the above problem, the inventor proposes an image information processing method, an apparatus, an electronic device, and a storage medium provided by the present application, which can realize that: regardless of the kind of the color gamut space of a target interface that will be shown, it is possible to show the target interface in the most realistic state, thereby improving user experience.

An environment for running an embodiment of the present application is first introduced below.

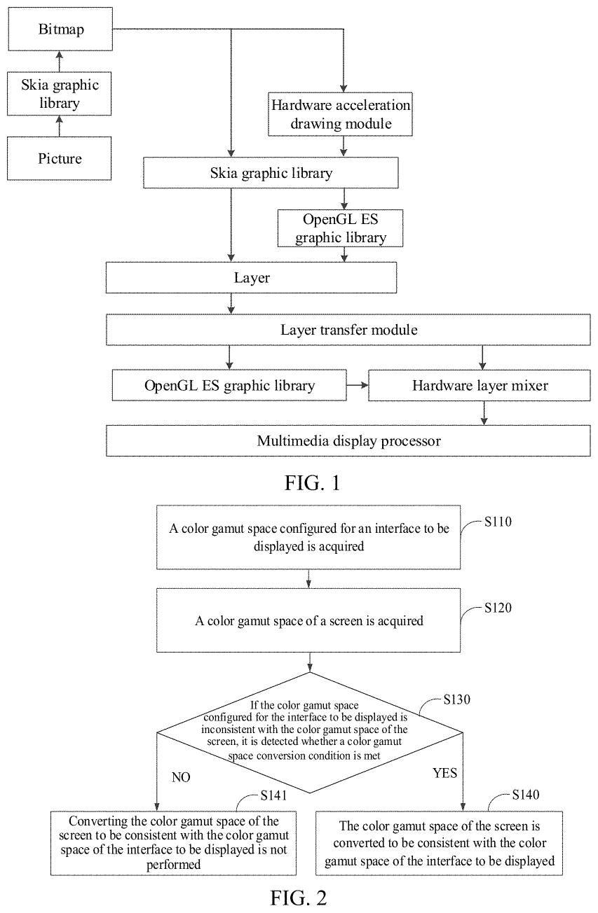

As shown in FIG. 1, in an embodiment of the present application, color gamut conversion processing in an interface (such as activity) is performed in Canvas; the interface which will perform color gamut conversion will be first processed by a graphics processing function library (Skia) to obtain a corresponding bitmap, and then perform color gamut conversion based on the bitmap. In the color gamut conversion process, the color gamut conversion will be first performed based on a hardware accelerated drawing (rendering) module (HWUI) or the graphics processing function library (Skia), then the interface is processed by OpenGL ES (a graphics library), a layer module (Surface), a layer transfer module (Surface Flinger), a hardware layer mixer (HWC) and a multimedia display processor (MDP), and finally displayed on a screen.

Content of the present application will be introduced with reference to specific embodiments below.

Referring to FIG. 2, an image information processing method provided by the present application is applied to an electronic device with a screen, wherein the screen supports displaying images based on multiple kinds of color gamut spaces; the method comprises the follows.

Operation S110: a color gamut space configured for an target interface is acquired.

In this embodiment, the target interface is an interface to be displayed; multiple kinds of interfaces can be used as the target interface.

As a way, an interface that is not displayed in an application, such as a desktop background, a startup interface, etc., can be used as the target interface.

As another way, a target interface by a target application is used as the target interface. Among them, the target application is an application currently running in the foreground. It is understandable that, during a running process, the application can automatically perform switching for interfaces, or perform switching for interfaces in response to a manual operation of a user. Thus, the electronic device can use an interface which is switched to during the interface switching process as the target interface. For example, an application running in the foreground currently displays an interface A, then after detecting that a user has triggered an operation for displaying an interface B, the electronic device will use the interface B as the target interface.

Furthermore, as yet another way, the target application may be an application to be started. It is understandable that after the application is started, a preset homepage interface will be displayed. In this case, the target interface is the homepage interface displayed by the application to be started after being started.

Among them, in this case that the target interface is the interface to which the application belongs, each interface can be individually configured with a corresponding color gamut space, or a color gamut space can be configured for all interfaces in a unified manner.

For example, if an application includes an interface A, an interface B, and an interface C, it is possible to configure the interface A to correspond to the sRGB color gamut, configure the interface B to correspond to the Adobe RGB color gamut, and configured the interface C to correspond to the DCI-P3 color gamut. Of course, the color gamut corresponding to each interface is not limited to the above manner, for example, it is also possible to configure the interface A to correspond to the DCI-P3 color gamut, configure the interface B to correspond to the sRGB color gamut, and configured the interface C to correspond to the Adobe RGB color gamut.

As a way, a configuration file can be established to store the color gamut space corresponding to each interface, and the configuration file can be encapsulated in the installation file of the application, for example, in the apk file of the Android system. In this way, the electronic device can obtain the color gamut space of each interface in the application by reading the configuration file of the application.

It should be noted that the configuration files of some applications can only allow the applications themselves to access. In this case that the color gamut spaces of the interfaces of the applications are stored by the configuration files, the electronic device may not effectively obtain the color gamut space configured for each interface in the application. In this case, it is possible to establish a public configuration file that can be accessed by third-party applications, other than the system program, in the electronic device. The public configuration file can be used to store some non-confidential information, for example, the developer of the application, the version number of the application, or the color gamut space configured for the application, etc. Then in this way, when it is detected that an application is installed, the installed application can take the initiative to store the developer of its own application, the version number of the application, or the color gamut space configured for the application into the public configuration file. Of course, when storing, an identifier of the application is also stored so that the application to which the information stored in the public configuration file belongs can be identified. Among them, the identifier of the application may be a package name.

Thus, based on the above method, when the electronic device needs to obtain the color gamut space of a certain interface of a certain application, this can be realized by querying the aforementioned public configuration file, so that even in the case that the electronic device cannot directly obtain the configuration file of the application itself, the color gamut space configured for each interface in the application can still be obtained.

It should be noted that the information stored in the aforementioned public configuration file is not limited to the aforementioned exemplarily mentioned developer of the application, version number of the application, or color gamut space configured for the application, and may also include more information. For example, it may also include permission information that is required to be obtained by the application.

Operation S120: a color gamut space of a screen is acquired.

As one way, it is possible to configure a file in the system of the electronic device to store the current color gamut space of a screen. Thus, in this way, the electronic device can obtain the color gamut space of the screen by means of reading the file.

Operation S130: if the color gamut space configured for the target interface is inconsistent with the color gamut space of the screen, it is detected whether a color gamut space conversion condition is met.

Operation S140: if the color gamut space conversion condition is met, the color gamut space of the screen is converted to be consistent with the color gamut space of the target interface.

Operation S141: if the color gamut space conversion condition is not met, converting the color gamut space of the screen to be consistent with the color gamut space of the target interface is not performed.

It should be noted that there can be multiple kinds of color gamut space conversion conditions in embodiments of the present application.

As one way, a color gamut space conversion condition represents whether resources of a current electronic device allow color gamut conversion. It is understandable that the color gamut space conversion of the electronic device requires processor resources and power resources. Then in this manner, the color gamut space conversion condition may be that when the current processing resources of the electronic device are relatively tight or the power is relatively low, the color gamut space conversion is not allowed. It is understandable that a method of configuring a threshold can be used to enable the electronic device to detect whether the current processing resources are relatively tight or the power is relatively low. For example, a CPU occupancy rate threshold can be configured for processing resources. When the electronic device detects that a current CPU occupancy rate is higher than the aforementioned occupancy rate threshold, it indicates that the current CPU is running under high load, and then it is determined not to perform color gamut conversion. Similarly, a low power threshold can also be configured for the power. When the electronic device detects that the current power is lower than the aforementioned low power threshold, it indicates that the current power is low, and then it is determined not to perform color gamut conversion.

As another way, the color gamut space conversion condition represents whether a current electronic device has started performing color gamut conversion.

Optionally, whether to start performing color gamut space conversion may be for the overall situation of the electronic device, and can also be for a certain single application. In the manner for a certain single application, an electronic device can set a configuration interface, so that a user can control which application can start color gamut conversion when displaying an interface, and which application will not start color gamut conversion when displaying an interface. For applications that can and cannot perform color gamut conversion configured in the interface, they can be distinguished by means of creating a list.

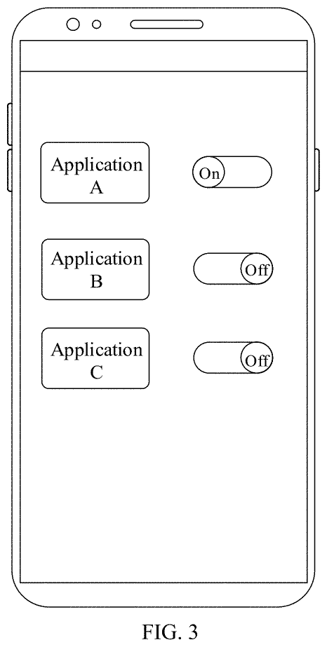

For example, as shown in FIG. 3, a plurality of applications and a state of a control corresponding to each application are displayed in the interface shown in FIG. 3. It is understandable that if a state of a control corresponding to an application is “OFF” as shown in the figure, it means that the application is removed or not added into the above list. If a status of a control corresponding to an application is “ON” as shown in the figure, it means that the application is added into the above list. For example, for an application named “Application A”, a state of its corresponding control is “ON”, this means that the application “Application A” will exist in the aforementioned list. For the application named “Application B”, a state of its corresponding control is “OFF”, then this means that the application “Application B” will not exist in the aforementioned list. It is understandable that an application existing in the list indicates that color gamut conversion will be stated when an interface is displayed.

Among them, it is understandable that the electronic device can establish a variable, and then use a variable value to identify a state of a control. For example, if the variable value is 0, it means that a control is in a state representing that color gamut conversion is turned off; and if the variable value is 1, it means that a control is in a state representing that color gamut conversion is turned on. Then in this case, when the electronic device detects that it is in a video playing state, it can detect the variable value to determine a state of a control.

Optionally, the variable value can be stored in a data table established in advance. In this case, when the electronic device detects that it is in a video playing state, it can obtain the aforementioned variable value by looking up the table, and then determine a state of a control.

In addition, when a certain application is installed in the electronic device, a storage location of its corresponding configuration file is relatively fixed. As another way, the variable value can also be stored in the configuration file of a corresponding video playback application. In this case, when the electronic device detects that a video playback application is installed, and detects that the installed video playback application is set as a default video playback application, it can find any file in a txt format in a configuration folder of the video playback application, then add a variable into the found file in a txt format, and use a value of the variable as the aforementioned variable value. In this way, it is possible to use the configuration file of the application itself to realize state detection of the control without adding new files, and because the configuration file of the application itself is used, a state of control corresponding to a certain application can be distinguished well.

In this case, in order to avoid influence on original functions of configuration files, as one way, its is possible to add a variable into a configuration file in the form of comments. For example, for a file in a txt format, characters beginning with “//” or “/*” are used to comment content. Then in this case, when a variable configured for the electronic device is hqv, content inserted into the txt file can be “//hqv=1”, which means that color gamut conversion is turned on.

It should be noted that after some applications are updated or reinstalled, their corresponding configuration files will be modified or replaced by other files. Then in this case, if it is detected that a set application is updated or reinstalled, it is possible to first detect whether a previously selected file in a txt format still exists. If it exists, it is further detected whether a previously inserted variable can be read in the previously selected txt file corresponding to the updated or reinstalled application; if the reading fails, the variable is inserted again in the aforementioned manner. If it is detected that the previously selected file in a txt format does not exist, a txt file is reselected.

The above content is illustrated below through a specific application.

When the electronic device detects that the application named Application A is installed, it will further detect whether the Application A is configured as an application in the aforementioned list. If it is detected that the Application A is configured as an application in the aforementioned list, the electronic device then will further search for files in a txt format from a folder storing configuration files of the Application A. After any file with a name of tx.txt is searched, a piece of data will be inserted into the tx.txt, wherein content of the data is “//hqv=1”, which indicates that a control corresponding to the Application A is in a state representing that color gamut conversion is turned on. Thus, when it is correspondingly detected that the control corresponding to the Application A is touched, the electronic device will correspondingly amend the originally inserted content into “//hqv=0”, so as to indicate that the control corresponding to the Application A is in a state representing that color gamut conversion is turned off.

Thus, when the electronic device detects that Application A is updated or reinstalled, it will detect whether the file tx.txt still exists in the configuration file corresponding to the Application A; if it exists, it is further detect whether the content “//hqv=1” or “//hqv=0” can still be read from tx.txt; if can, it is represented that the previous configuration is still available; if it cannot be read, “//hqv=1” is inserted into tx.txt as default. If the electronic device finds that the tx.txt file cannot be found, a txt file can be reselected.

It should be noted that the selected variable storage file corresponding to each application can be stored in the electronic device in the form of a data table for the electronic device to search. It should be noted that the aforementioned files in a txt format and variable values are all exemplary, and the present application does not make specific limitations. The electronic device can specifically set according to format files that can be found. For example, it is also possible to use files in an xml format to store variable values.

Thus, in this case, the electronic device can first detect which application is currently running in the foreground, and then further detect whether the application currently running in the foreground is in the list, if it is, then it is determined that it is currently in a video playback state. Among them, as one way, if the electronic device has an Android operating system, a name of the application currently running in the foreground can be obtained by executing the getRunningTasks method of the ActivityManager. In addition, the electronic device can also obtain a list of applications used by a user through the UsageStatsManager, and identify the most recently used application recorded in the list as the current foreground application. Furthermore, it is also possible to monitor change of a window focus through Android's own barrier-free function, and get a package name corresponding to a focused window as the application currently running in the foreground.

As yet another way, the color gamut space conversion condition can represent whether it is currently necessary to perform color gamut space conversion. Even though color gamut space conversion is not performed, a target interface can still be enabled to display good realness.

Optionally, the color gamut space conversion condition includes that: a saturation of the target interface is lower than a specified saturation value, and a color gamut space range of the target interface is smaller than a color gamut space range of a screen. It is understandable that when a corresponding interface with a narrower color gamut space is directly displayed on a screen with a wider color gamut space, it may result in that the interface appears dim. However, if a saturation of the interface itself is higher, the high saturation can offset the dim effect, thereby make the display effect of the interface not become worse or lose authenticity even more.

The color gamut space conversion condition, besides including the above manner, and may also include that the saturation of the target interface is greater than a specified exposure degree value, and the color gamut space range of the target interface is greater than the color gamut space range of the screen.

In the image information processing method provided by the present application, by acquiring a color gamut space of a target interface and acquiring a color gamut space of a screen, the color gamut space of the target interface is compared with the color gamut space of the screen; if the color gamut space of the target interface is inconsistent with the color gamut space of the screen, and a color gamut space conversion condition is met, the color gamut space of the screen is converted to be consistent with the color gamut space of the target interface. By the method, regardless of the kind of the color gamut space of the target interface that is to be presented, the target interface can be presented in the most realistic state, such that the user experience is improved.

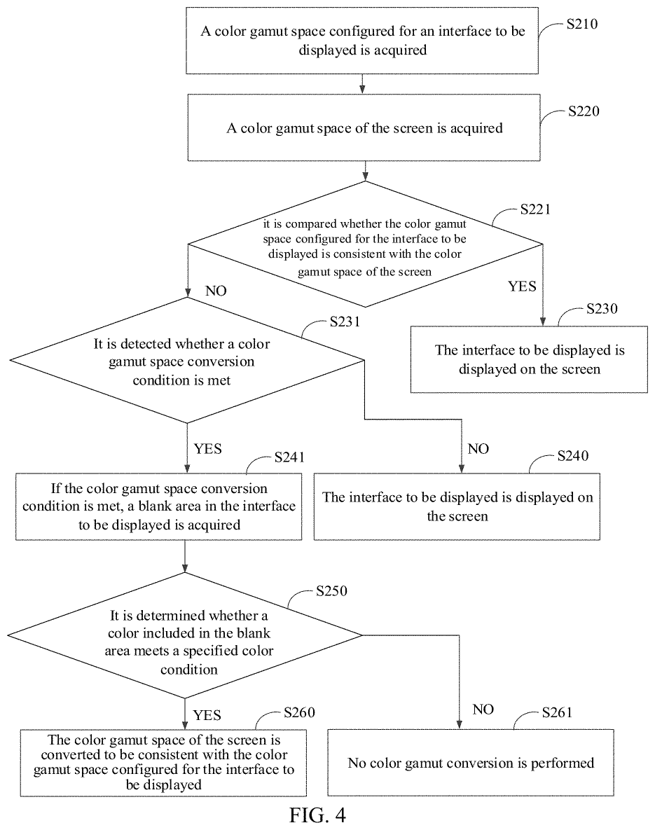

Referring to FIG. 4, an image information processing method provided by the present application is applied to an electronic device with a screen, wherein the screen supports displaying images based on multiple kinds of color gamut spaces; the method includes the follows.

Operation S210, a color gamut space configured for a target interface is acquired.

Operation S220, a color gamut space of the screen is acquired.

Operation S221, it is compared whether the color gamut space configured for the target interface is consistent with the color gamut space of the screen.

Operation S230, if the color gamut space configured for the target interface is consistent with the color gamut space of the screen, the target interface is displayed on the screen.

Operation S231, if the color gamut space configured for the target interface is inconsistent with the color gamut space of the screen, it is detected whether a color gamut space conversion condition is met.

Operation S240, if the color gamut space conversion condition is not met, the target interface is displayed on the screen.

Operation S241, if the color gamut space conversion condition is met, a blank area in the target interface is acquired.

In one embodiment, the blank area is an area in which no file, such as image, character, or video, is displayed.

It should be noted that there are usually multiple areas for an interface of an application. For example, a area used to display content or an area where only a background color or a background image is displayed. Among them, an electronic device can obtain a blank area through a configuration file of the application. For example, in the Android system, an application is configured with a corresponding XML file. The XML file is used to describe layout of components of each interface. It is understandable that content in the interface is usually displayed by the components, and thus the electronic device may use an area other than areas where a component for displaying image content, a component for displaying video content, and a control (for example, a button control) for responding to users' touches are disposed as a blank area. For another example, in a web page, areas where image content or video content is to be introduced are usually configured with dedicated tags. For example, an “<IMG>” tag can be used to introduce a picture, and a “<video>” tag can be used to introduce a video. Thus, the electronic device can recognize an area other than areas required to be occupied by the aforementioned tag used to introduce a picture or a video as a blank area.

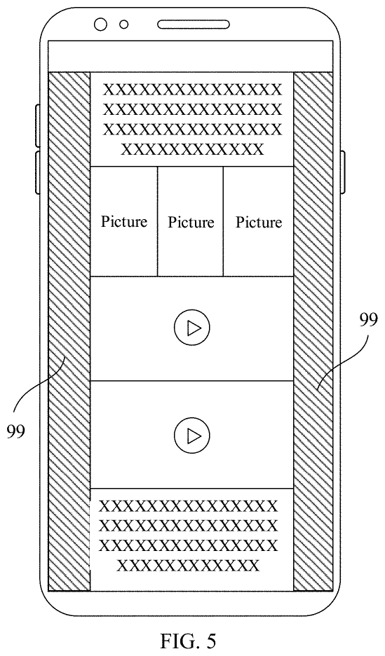

Among them, the displayed content may be picture content or video content. For example, as shown in the interface shown in FIG. 5, the interface shown in FIG. 5 includes an area 99 where no content is displayed (the shaded part in the figure) and an area where content is displayed (the non-shaded part), wherein the shaded part can be understood as a background image area of the interface. The background image can be obtained by filling in pictures, and can also be obtained by filling in colors. It is understandable that the background image in the interface is usually an area in the interface that mainly requires designing styles and colors. In the same way, the aforementioned blank area in the interface is an area that mainly requires designing styles and colors.

In this case, if whether the blank area performs color gamut conversion or whether the screen performs color gamut conversion has no effect on display effect of the blank area while color gamut conversion is still performed, it will result in that the color gamut conversion is ineffective and then cause unnecessary resource consumption. For example, if colors displayed in the blank area, when it is displayed, are all black (that is, it can be understood that an RGB value of each pixel in the blank area is 0), then although displayable color ranges corresponding to different color gamut spaces are different, the difference is very small regarding display effect of an achromatic color. Therefore, in the case that colors displayed in the blank area are all black when it is displayed, a user will not obviously perceive display effect brought about by color gamut conversion. For another example, it is similar for achromatic colors such as white and gray.

However, regarding chromatic colors, such as red, yellow, blue, green, and purple, there will be a clear difference. For example, for a specific green in the Adobe RGB color gamut, it is actually outside the color gamut of the sRGB color gamut. In this case, if the color gamut of the interface is the Adobe RGB color gamut, while that of the screen is the sRGB color gamut, it will cause the interface to fail to show the display effect as it was designed, and then cause influence on the authenticity of UI design.

Thus, in order to overcome the above problem, it is possible to determine whether to perform color gamut conversion by judging a color of a blank area.

Operation S250, it is determined whether a color included in the blank area meets a specified color condition.

Among them, the specified color condition can have multiple manners.

As one way, the specified color condition includes that: colors of the blank area include at least one chromatic color. As described in the aforementioned content, regarding chromatic colors, effect appearing in different color gamut spaces will have difference. Thus, in the case that the blank area includes at least one chromatic color, in order to ensure that the originally designed color effect can be reproduced, it is required to perform color gamut space matching, that is, to make the color gamut space of the screen be consistent with the color gamut space of the target interface.

As another way, the specified color condition includes that: a proportion of a first area in the blank area is greater than a target extent, wherein a color displayed in the first area is chromatic colors while the first area is displayed. It can be understood that color gamut conversion occurs before a target interface is rendered, that is, in a case that color gamut conversion is to be performed, rendering is performed after the color gamut conversion is completed so that it can be displayed to a user visually. Thus, the electronic device can obtain color data (for example, RGB values) of each pixel in the target interface before rendering, and then obtain color data of each pixel in the blank area, so as to identify whether the color of the pixel is a chromatic color through the color data, and then further compare the number of pixels belonging to chromatic colors with the total number of pixels in the blank area to obtain the occupation of the first area. Among them, the target extent can be set in advance, for example, set as 70% or 60%.

Operation S260, if the color included in the blank area meets the specified color condition, the color gamut space of the screen is converted to be consistent with the color gamut space configured for the target interface.

It can be understood that the target interface will be displayed on the screen after completing the color gamut space conversion.

Operation S261, if the color included in the blank area does not meet the specified color condition, no color gamut conversion is performed.

In the image information processing method provided by the present application, by the method, regardless of the kind of the color gamut space of the target interface that is to be presented, the target interface can be presented in the most realistic state, such that the user experience is improved. Moreover, before performing color gamut conversion, it is possible to determine whether to perform color gamut conversion by judging whether a color of a blank area in the target interface meets a specified color condition, such that effectivity of color gamut conversion is further improved.

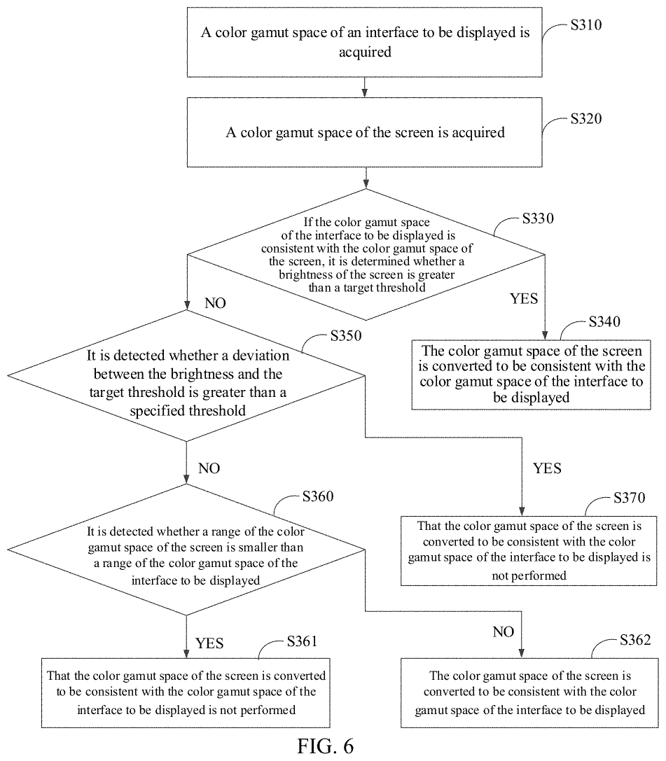

Referring to FIG. 6, an image information processing method provided by the present application is applied to an electronic device with a screen, wherein the screen supports displaying images based on multiple kinds of color gamut spaces; the method includes the follows.

Operation S310, a color gamut space of a target interface is acquired.

Operation S220, a color gamut space of the screen is acquired.

Operation S330, if the color gamut space of the target interface is consistent with the color gamut space of the screen, it is determined whether a brightness of the screen is greater than a target threshold.

Operation S340, if it is determined that the brightness of the screen is greater than the target threshold, the color gamut space of the screen is converted to be consistent with the color gamut space of the target interface.

It should be noted that when the brightness of the screen is lower than a certain brightness value, it is not particularly obvious whether the displayed interface is dim or oversaturated. Thus, if the color gamut conversion is still performed, it may cause resource waste. Therefore, only when it is recognized that the brightness of the screen is greater than the target threshold, the color gamut space of the screen is converted to be consistent with the color gamut space of the target interface, so that the performed color gamut conversion can actually play a role in improving the user experience.

As one way, the target threshold can be a current screen brightness manually set by a user. As another way, the target threshold is a screen brightness automatically set according to light intensity of a current external environment by the electronic device.

Operation S350, if the brightness of the screen is not greater than the target threshold, it is detected whether a deviation between the brightness and the target threshold is greater than a specified threshold.

It can be understood that the deviation in this embodiment represents a size of a difference between an actual brightness of the screen and the aforesaid target threshold.

As described in the foregoing content, the target threshold may be a current screen brightness manually set by a user, and may also be a screen brightness automatically set according to light intensity of a current external environment by the electronic device, or a pre-configured screen brightness of which a color change can be clearly perceived. It should be noted that a screen brightness manually set by a user is usually brighter than a brightness automatically adjusted according to ambient light by the electronic device, that is, the brightness value is higher. As one way, in a case that the electronic device recognizes that automatic adjustment of the screen brightness based on ambient light is not currently turned on, a specified threshold corresponding to the deviation is set as a first specified threshold; in a case that the electronic device recognizes that automatic adjustment of the screen brightness based on ambient light is currently turned on, a specified threshold corresponding to the deviation is set as a second specified threshold, wherein the first specified threshold is greater than the second specified threshold.

Operation S360, if the deviation is not greater than the specified threshold, it is detected whether a range of the color gamut space of the screen is smaller than a range of the color gamut space of the target interface.

Operation S361, if a range of the color gamut space of the screen is smaller than a range of the color gamut space of the target interface, that the color gamut space of the screen is converted to be consistent with the color gamut space of the target interface is not performed.

Operation S362, if a range of the color gamut space of the screen is greater than a range of the color gamut space of the target interface, that the color gamut space of the screen is converted to be consistent with the color gamut space of the target interface is performed.

It is understandable that if the range of the color gamut space of the screen is greater than the range of the color gamut space of the target interface, the interface displayed on the screen will be dimmer relative to the real situation of the target interface in a case that no color gamut space conversion is performed. However, if the range of the color gamut space of the screen is smaller than the range of the color gamut space of the target interface, the interface displayed on the screen will be more oversaturated relative to the real situation of the target interface in a case that no color gamut space conversion is performed. Thus, in a case that the deviation is not greater than the specified threshold, although a current actual brightness is lower than a screen brightness of which a color change can be clearly perceived, because the oversaturated display effect of the interface will offset with the current effect that the actual brightness that is relatively dark (darker relative to the target threshold) even if no color gamut conversion is not performed, users' visual experience will not affected too much even if no conversion is performed. Therefore, in this case, for the purpose of saving energy source, color gamut conversion may not be performed.

Operation S370, if the deviation is greater than the specified threshold, that the color gamut space of the screen is converted to be consistent with the color gamut space of the target interface is not performed.

It can be understood that if the deviation is greater than the specified threshold, it represents that the current brightness of the current screen is low, such that a user cannot effectively perceive effect brought by color gamut conversion. Thus, in this situation, for the purpose of saving energy source, color gamut conversion may not be performed.

In the image information processing method provided by the present application, by the method, regardless of the kind of the color gamut space of the target interface that is to be presented, the target interface can be presented in the most realistic state, such that the user experience is improved. Moreover, in the case that it is recognized that the color gamut space of the target interface is inconsistent with the color gamut space of the screen, it is possible to determine whether to perform color gamut conversion based on a current brightness of the current, so as to improve focalization and flexibility of conversion.

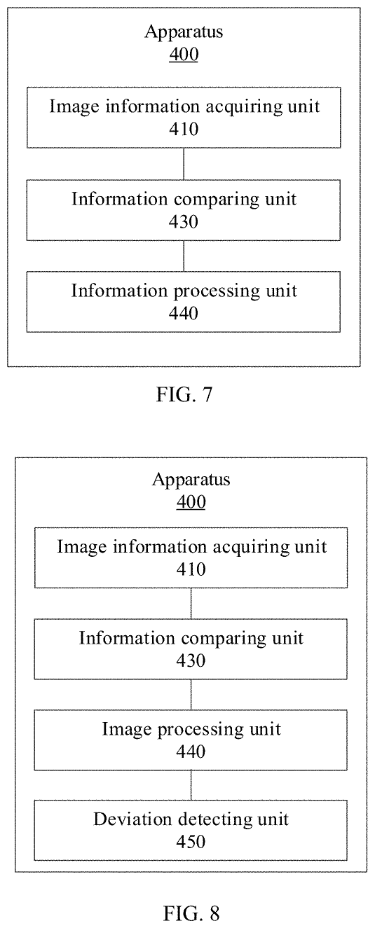

Referring to FIG. 7, the present application provides an image information processing apparatus 400 running in an electronic device with a screen, wherein the screen supports displaying images based on multiple kinds of color gamut spaces; the apparatus 400 includes the follows.

An image information acquiring unit 410 is configured to acquire a color gamut space configured for a target interface.

As one way, the image information acquiring unit 410 is specifically configured to: use a target interface by a target application as the target interface; acquire parameters in configuration information of the target application that represents a color gamut space; and use the color gamut space represented by the parameters as a color gamut space configured for the target interface.

The image information acquiring unit 410 is further configured to acquire a color gamut space of a screen.

An information comparing unit 430 is configured to compare the color gamut space of the target interface with the color gamut space of the screen.

An information processing unit 440 is configured to: if the color gamut space of the target interface is inconsistent with the color gamut space of the screen, detect whether a color gamut space conversion condition is met; and if the color gamut space conversion condition is met, convert the color gamut space of the screen to be consistent with the color gamut space of the target interface.

Optionally, as one way, the color gamut space conversion condition includes: identifying that a brightness of the screen is greater than a target threshold. In this embodiment, as shown in FIG. 8, the apparatus further includes a deviation detecting unit 450 configured to: if the brightness of the screen is not greater than the target threshold, detect a deviation between the brightness and the target threshold; if the deviation is not greater than a specified threshold and a range of the color gamut space of the screen is greater than a range of the color gamut space of the target interface, not perform converting the color gamut space of the screen to be consistent with the color gamut space of the target interface. If the deviation is greater than the specified threshold, the operation of converting the color gamut space of the screen to be consistent with the color gamut space of the target interface is not performed.

As another way, the color gamut space conversion condition includes: an exposure degree of the target interface is smaller than a specified exposure degree value, and the range of the color gamut space of the target interface is smaller than the range of the color gamut space of the screen; or an exposure degree of the target interface is greater than a specified exposure degree value, and the range of the color gamut space of the target interface is greater than the range of the color gamut space of the screen.

As one way, the information processing unit 440 is specifically configured to: acquire a blank area in the target interface, wherein the blank area is an area in which no content is displayed; if a color included in the blank area meets a specified color condition, convert the color gamut space of the screen to be consistent with the color gamut space configured for the target interface. Optionally, the specified color condition includes: a proportion of a first area in the blank area is greater than a target extent, wherein a color displayed in the first area is chromatic colors while the first area is displayed.

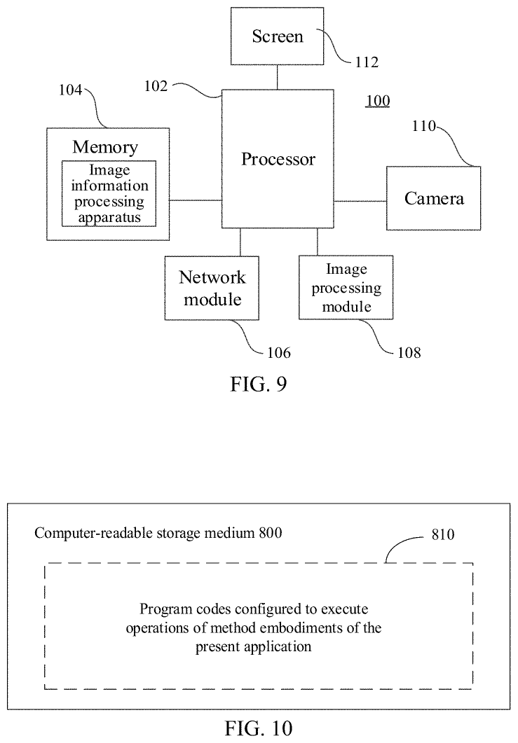

An electronic apparatus provided by the present application will be illustrated below with reference to FIG. 9.

Referring to FIG. 9, based on the aforementioned image processing method and apparatus, an embodiment of the present application further provides another electronic device 100 that can execute the aforementioned terminal control method. The electronic device 100 includes one or more (only one is shown in the figure) processor 102, a memory 104, a network module 106, an image processing module 108, a camera 110, and a screen 112 supporting displaying images based on multiple kinds of color gamut spaces, which are coupled with each other. Among them, the memory 104 stores a program that can execute the content of the aforementioned embodiments, and the processor 102 can execute the program stored in the memory 104.

Among them, the processor 102 may include one or more processing cores. The processor 102 uses various interfaces and lines to connect various parts of the entire electronic device 100, and executes various functions of the electronic device 100 and processing data by running or executing instructions, programs, code sets, or instruction sets stored in the memory 104, and calling data stored in the memory 104. Optionally, the processor 102 may use at least one kind of hardware form in Digital Signal Processing (DSP), Field-Programmable Gate Array (FPGA), and Programmable Logic Array (PLA) to realize. The processor 102 may be integrated with one or a combination of several of a central processing unit (CPU), a graphics processing unit (GPU), a modem, and the like. Among them, the CPU mainly processes an operating system, user interfaces, and applications, etc.; the GPU is used for rendering and drawing of display content; the modem is used for processing wireless communication. It can be understood that the above-mentioned modem may also not be integrated into the processor 102, but be implemented by an individual communication chip.

The memory 104 may include a random access memory (RAM), and may also include a read-only memory, for example, an image information processing apparatus may be stored in the memory 104. The image information processing apparatus may be the aforementioned apparatus 400. The memory 104 may be used to store instructions, programs, codes, code sets or instruction sets. The memory 104 may include a program storage area and a data storage area, wherein the program storage area can store instructions for implementing an operating system and instructions for implementing at least one function (such as a touch function, a sound playback function, an image playback function, etc.), and instructions used to implement the following various method embodiments, etc. The storage data area can also store data created by the electronic device 100 during use (such as a phone book, audio and video data, chat record data), and the like.

The network module 106 is used to receive and transmit electromagnetic waves, realize mutual conversion between electromagnetic waves and electrical signals, so as to perform communication with a communication network or other devices, such as communication with a wireless access point. The network module 106 may include various existing circuit elements for performing these functions, for example, an antenna, a radio frequency transceiver, a digital signal processor, an encryption/decryption chip, a subscriber identity module (SIM) card, a memory, etc. The network module 106 can communicate with various networks, such as the Internet, an intranet, and a wireless network, or communicate with other devices through a wireless network. The aforementioned wireless network may include a cellular telephone network, a wireless local area network, or a metropolitan area network.

The image processing module 108 may be used to encode images collected by the camera 110, or decode data requested from the network by the network module 106, so as to transmit them to the screen 112 for display. Specifically, the image processing module 108 may be a GPU, a dedicated DSP, an FPGA, an ASIC chip, and so on.

Referring to FIG. 10, which shows a structural block diagram of a computer-readable storage medium provided by an embodiment of the present application. The computer-readable storage medium 800 stores program codes, the program codes can be called by a processor to execute the methods described in the aforementioned embodiments.

The computer-readable storage medium 800 may be an electronic memory such as a flash memory, an EEPROM (Electrically Erasable Programmable Read Only Memory), an EPROM, a hard disk, an ROM, and so on. Optionally, the computer-readable storage medium 800 includes a non-transitory computer-readable storage medium. The computer-readable storage medium 800 has storage space for program codes 810 for executing any method steps in the above-mentioned methods. These program codes can be read from one or more computer program products or written into one or more computer program products. The program code 810 may be compressed in a suitable form, for example.

In conclusion, in the image information processing method, apparatus, electronic device, and storage medium provided by the present application, by acquiring a color gamut space configured for a target interface and acquiring a color gamut space of a screen, the color gamut space configured for the target interface is compared with the color gamut space of the screen; if the color gamut space configured for the target interface is inconsistent with the color gamut space of the screen, and a color gamut space conversion condition is met, the color gamut space of the screen is converted to be consistent with the color gamut space configured for the target interface. By the method, even though the originally designed color gamut space of the target interface that is to be presented is inconsistent with that of the screen, the target interface can still be presented in the most realistic state, such that the user experience is improved.

Finally, it should be noted that the above embodiments are only used to illustrate technical solutions of the present application, but not to limit them. Although the present application has been described in detail with reference to the foregoing embodiments, those of ordinary skill in the art should understand that: it is still possible to modify the technical solutions recorded in the foregoing embodiments, or equivalently replace some technical features therein; these modifications or replacements do not drive the essence of corresponding technical solutions to deviate from spirit and scope of the technical solutions of the embodiments of the present application.

What is claimed is:

1. An image information processing method, comprising:
acquiring a color gamut space of a target interface and a color gamut space of a screen;
in response to that the color gamut space of the target interface is inconsistent with the color gamut space of the screen, detecting whether a color gamut space conversion condition is met; and
in response to that the color gamut space conversion condition is met, converting the color gamut space of the screen to be consistent with the color gamut space of the target interface.

2. The method according to claim 1, wherein the converting the color gamut space of the screen to be consistent with the color gamut space of the target interface comprises:
acquiring a blank area in the target interface; and
in response to that a color included in the blank area meets a specified color condition, converting the color gamut space of the screen to be consistent with the color gamut space of the target interface.

3. The method according to claim 2, wherein the specified color condition comprises that:
a proportion of a first area in the blank area is greater than a target extent, wherein a color displayed in the first area is chromatic colors while the first area is displayed.

4. The method according to claim 2, further comprising:
in response to that the color included in the blank area does not meet the specified color condition, not performing color gamut conversion.

5. The method according to claim 1, wherein the acquiring a color gamut space of a target interface comprises:
taking a target interface by a target application as the target interface;
acquiring parameters in configuration information of the target application that represent a color gamut space; and
taking the color gamut space represented by the parameters as the color gamut space of the target interface.

6. The method according to claim 5, wherein the target application includes an application currently running in a foreground, and the taking a target interface by a target application as the target interface comprises:
taking an interface which is switched to by the application currently running in a foreground as the target interface.

7. The method according to claim 6, further comprising:
acquiring a using list record of applications; and
identifying a most recently used application in the using list record as the application currently running in a foreground.

8. The method according to claim 5, wherein the target application includes an application to be started, and the taking a target interface by a target application as the target interface comprises:
taking an interface of a first page displayed by the application to be started after being started as the target interface.

9. The method according to claim 1, wherein the color gamut space conversion condition comprises:
identifying that a brightness of the screen is greater than a target brightness threshold.

10. The method according to claim 9, further comprising:
in response to that the brightness of the screen is not greater than the target brightness threshold, detecting a deviation between the brightness and the target threshold;
in response to that the deviation is not greater than a specified deviation threshold, and a range of the color gamut space of the screen is smaller than a range of the color gamut space of the target interface, not performing the converting the color gamut space of the screen to be consistent with the color gamut space of the target interface; and
in response to that the deviation is not greater than a specified deviation threshold, and a range of the color gamut space of the screen is greater than a range of the color gamut space of the target interface, performing the converting the color gamut space of the screen to be consistent with the color gamut space of the target interface.

11. The method according to claim 10, wherein the target brightness threshold comprises a current brightness of the screen or a screen brightness set according to light intensity of a current external environment by an electronic device.

12. The method according to claim 11, further comprising:
in response to that the deviation is not greater than a specified deviation threshold, not performing the converting the color gamut space of the screen to be consistent with the color gamut space of the target interface.

13. The method according to claim 1, wherein the color gamut space conversion condition comprises:
a saturation of the target interface is lower than a specified saturation value, and a color gamut space range of the target interface is smaller than a color gamut space range of a screen; or
a saturation of the target interface is greater than a specified saturation value, and a color gamut space range of the target interface is greater than a color gamut space range of a screen.

14. The method according to claim 1, further comprising:
in response to that the color gamut space conversion condition is not met, not performing the converting the color gamut space of the screen to be consistent with the color gamut space of the target interface.

15. The method according to claim 1, further comprising:
in response to that the color gamut space conversion condition is not met, displaying the target interface on the screen.

16. The method according to claim 1, further comprising:
in response to that the color gamut space of the target interface is consistent with the color gamut space of the screen, displaying the target interface on the screen.

17. An electronic device, comprising one or more processor, a video codec, and a memory;
wherein one or more program is stored in the memory and configured to be executed by the one or more processor, and the one or more program is configured to execute the following operations:
acquiring a color gamut space of a target interface and a color gamut space of a screen;
in response to that the color gamut space of the target interface is inconsistent with the color gamut space of the screen, detecting whether a color gamut space conversion condition is met; and
in response to that the color gamut space conversion condition is met, converting the color gamut space of the screen to be consistent with the color gamut space of the target interface.

18. The electronic device according to claim 17, wherein the converting the color gamut space of the screen to be consistent with the color gamut space of the target interface comprises:
acquiring a blank area in the target interface; and
in response to that a color included in the blank area meets a specified color condition, converting the color gamut space of the screen to be consistent with the color gamut space of the target interface.

19. The electronic device according to claim 17, wherein the acquiring a color gamut space of a target interface comprises:
taking a target interface by a target application as the target interface;
acquiring parameters in configuration information of the target application that represent a color gamut space; and
taking the color gamut space represented by the parameters as the color gamut space of the target interface.

20. A non-transitory computer-readable storage medium storing program codes, wherein the program codes, when being run by a processor, execute the following operations:
acquiring a color gamut space of a target interface and a color gamut space of a screen;
in response to that the color gamut space of the target interface is inconsistent with the color gamut space of the screen, detecting whether a color gamut space conversion condition is met; and
in response to that the color gamut space conversion condition is met, converting the color gamut space of the screen to be consistent with the color gamut space of the target interface.
